(19) United States
(12) Patent Application Publication
(10) Pub. No.: US 2024/0284069 A1
(43) Pub. Date: Aug. 22, 2024

(54) APPARATUS, METHOD, AND STORAGE MEDIUM

(71) Applicant: CANON KABUSHIKI KAISHA, Tokyo (JP)

(72) Inventor: KOHEI SATO, Tokyo (JP)

(21) Appl. No.: 18/436,980

(22) Filed: Feb. 8, 2024

(30) Foreign Application Priority Data
Feb. 21, 2023 (JP) 2023-025551

(51) Int. Cl. H04N 25/75; H04N 23/84; H04N 25/773

(52) U.S. Cl. CPC H04N 25/75; H04N 23/84; H04N 25/773

(57) ABSTRACT

An apparatus includes a sensor having a photodiode, at least one processor, and a memory coupled to the at least one processor, the memory storing instructions that, when executed by the at least one processor, cause the at least one processor to output a first image based on an output signal from the sensor, determine an adjustment method for an image based on at least one of a cumulative value of the output signal or a drive time of the apparatus, and output a second image acquired by adjusting the first image based on the adjustment method.

### BACKGROUND

### Technical Field

The aspect of the embodiments relates to a technique for image adjustment.

### Description of the Related Art

According to Japanese Patent Application Laid-Open No. 2018-88587, an image processing circuit is discussed that selects a reference color component from color components using at least one of an optical characteristic and edge information for each color component of a captured image and generates a reference image based on the reference color component. A correction unit uses the reference image and the optical characteristic to correct optical degradation in the color component so as to reduce a difference between an edge width in the color component and an edge width in the reference image.

According to Japanese Patent Application Laid-Open No. 2020-107973, an image processing apparatus is discussed in which each of a plurality of pixels includes a sensor unit that outputs a signal pulse in response to incidence of a photon and a counting unit that counts the number of signal pulses. A storage unit stores a parameter for compensating linearity of an image signal output from an imaging element for each wavelength band. A compensation unit compensates each image signal obtained from the imaging element using the parameter corresponding to the wavelength band of light received by the pixel that outputs the image signal.

### SUMMARY

According to an aspect of the embodiments, an apparatus includes a sensor having a photodiode, at least one processor, and a memory coupled to the at least one processor, the memory storing instructions that, when executed by the at least one processor, cause the at least one processor to output a first image based on an output signal from the sensor, determine an adjustment method for an image based on at least one of a cumulative value of the output signal or a drive time of the apparatus, and output a second image acquired by adjusting the first image based on the adjustment method.

Further features of the disclosure will become apparent from the following description of exemplary embodiments with reference to the attached drawings.

### BRIEF DESCRIPTION OF THE DRAWINGS

FIG. 1 illustrates a configuration example of an imaging apparatus.

FIG. 2 illustrates a configuration example of an achromatic processing unit.

FIG. 3 is a flowchart illustrating processing procedures.

FIGS. 4A and 4B illustrate an example of a degree of change.

FIGS. 5A and 5B illustrate a part of data in a three dimensional look-up table (3D-LUT).

FIG. 6 illustrates a relationship between the number of input photons and an output signal level of an imaging unit.

FIG. 7 is a flowchart illustrating processing procedures.

FIG. 8 illustrates a relationship between the number of input photons and a level of achromatic processing.

FIG. 9 illustrates a configuration example of the imaging unit.

### DESCRIPTION OF THE EMBODIMENTS

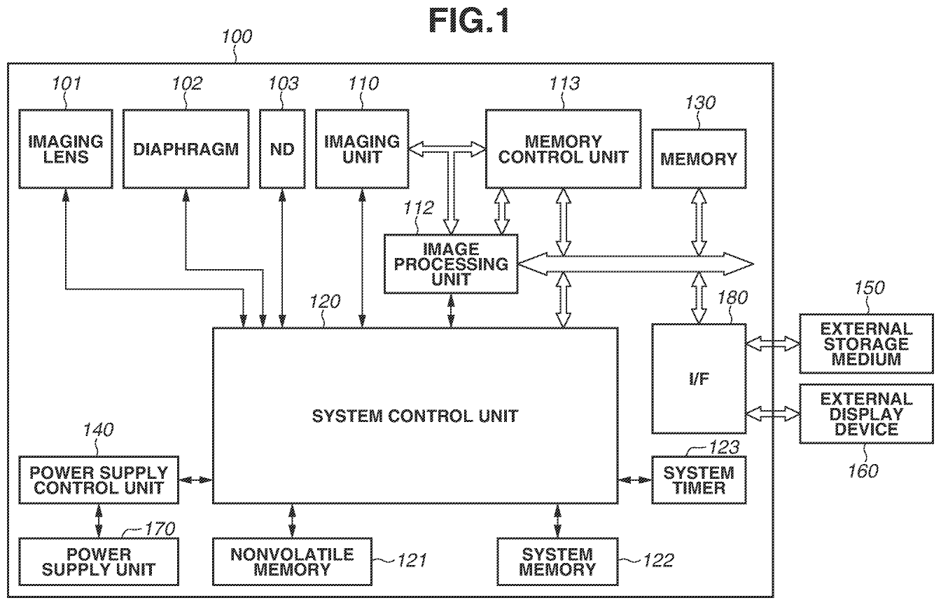

A first exemplary embodiment of the disclosure will be described below. FIG. 1 is a block diagram illustrating a configuration example of an imaging apparatus 100 according to the first exemplary embodiment. The imaging apparatus 100 includes an imaging lens 101, a diaphragm 102, a neutral density (ND) filter 103, an imaging unit 110, an image processing unit 112, a memory control unit 113, a system control unit 120, a nonvolatile memory 121, a system memory 122, and a system timer 123. The imaging apparatus 100 includes a memory 130, a power supply control unit 140, a power supply unit 170, and an interface (I/F) 180.

The imaging lens 101 is a lens group including a zoom lens, a focus lens, and a shift lens, and forms an object image. The diaphragm 102 is used to adjust an amount of light. The ND filter 103 is used to reduce light.

The imaging unit 110 includes an imaging element that includes a single photon avalanche diode (SPAD) sensor, performs photoelectric conversion, and outputs digital image data. The imaging unit 110 also has functions of controlling accumulation with an electronic shutter, changing a gain, changing a readout speed, and the like.

The image processing unit 112 performs image processing on image data from the imaging unit 110 or the memory control unit 113. The image processing includes, for example, predetermined pixel-interpolation processing, resizing processing such as reduction processing, detection processing for luminance information, color information, a characteristic object, and the like, color conversion processing, gamma correction processing, and digital gain addition processing. An image processing method includes image processing using a dedicated calculation circuit and image processing using a three dimensional look-up table (3D-LUT) processing circuit. The image processing unit 112 performs predetermined calculation processing using image data from the imaging unit 110 and transmits a calculation result to the system control unit 120.

The system control unit 120 performs exposure control, ranging control, white balance control, and the like based on the transmitted calculation result. Thus, through-the-lens (TTL) autofocus (AF) processing, auto exposure (AE) processing, auto white balance (AWB) processing, and the like are performed.

Output data from the imaging unit 110 is written into the memory 130 via the image processing unit 112 and the memory control unit 113, or via the memory control unit 113. The memory 130 stores image data from the imaging unit 110 or the image processing unit 112. The memory 130 is also used to temporarily store an image having been subjected to image processing by the image processing unit 112 and return the image to the image processing unit 112 again to apply other image processing. The memory 130 has a sufficient storage capacity to store a moving image and audio for a predetermined length of time.

The nonvolatile memory 121 is a memory that can electrically erase and record data and, for example, an electrically erasable and programmable read only memory (EEPROM) is used. The nonvolatile memory 121 stores a constant, a program, and the like for an operation of the system control unit 120. The program here refers to a program for executing processing in various flowcharts described below.

The system control unit 120 controls the imaging apparatus 100. The system control unit 120 executes the program stored in the nonvolatile memory 121 described above to execute each processing according to the present exemplary embodiment described below. A random access memory (RAM) is used as the system memory 122 and loads a constant, a variable, the program read from the nonvolatile memory 121, and the like for the operation of the system control unit 120.

The system timer 123 is a clocking unit that measures time used for various types of control and time of a built-in clock.

The power supply control unit 140 includes a battery detection circuit, a direct-current to direct-current (DC-DC) converter, and a switch circuit for switching blocks to be energized, and detects attachment of a battery, a type of the battery, and a remaining battery capacity. The power supply control unit 140 controls the DC-DC converter based on the detection result and an instruction from the system control unit 120 and supplies a necessary voltage to each unit including an external recording medium 150 for a necessary period.

The power supply unit 170 includes a primary battery, such as an alkaline battery and a lithium (Li) battery, a secondary battery, such as a nickel-cadmium (NiCd) battery, a nickel-metal hydride (NiMH) battery, and a Li ion battery, and an alternating current (AC) adapter. The I/F 180 is an interface with the external recording medium 150, such as a memory card and a hard disk, and an external display device 160. The external recording medium 150 is a recording medium such as a memory card for recording a captured image and exchanging data with an external device, and a semiconductor memory or the like is used.

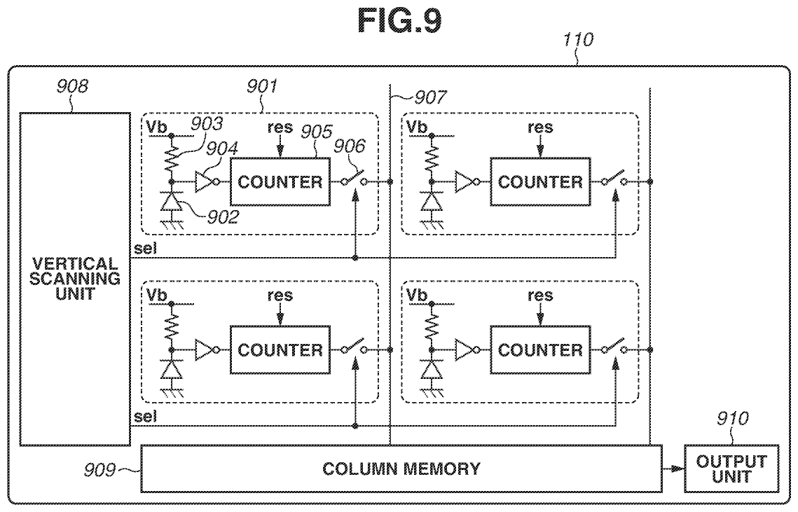

FIG. 9 illustrates a configuration example of the imaging unit (SPAD sensor) 110 in FIG. 1. The configuration of the imaging unit 110 and a method for reading out an image signal from the imaging unit 110 are described with reference to FIG. 9. As illustrated in FIG. 9, the imaging unit 110 includes a plurality of pixels 901, a vertical scanning unit 908, a column memory 909, and an output unit 910. In FIG. 9, two pixels 901 having the same structure are arranged in each of a row direction and in a column direction for the sake of description, but in practice, many more pixels 901 are arranged. The two pixels 901 arranged in the column direction are connected to a vertical signal line 907.

The imaging unit 110 is a light receiving element using a SPAD, and each pixel 901 includes an avalanche photodiode (APD) 902, a quench resistor 903, an inverter 904, a counter 905, and a readout switch 906. The pixel 901 is covered with color filters of a plurality of colors in order to acquire a color image. Light in different wavelength bands that has passed through the color filter is incident on each pixel 901. Various types of color filters may be used. For example, a primary color filter and a complementary color filter may be used. The type is not limited as long as it can acquire a color image. Here, a case is described as an example in which red (R), green (G), and blue (B) color filters in a Bayer arrangement are disposed.

The APD 902 is operated in a Geiger mode to detect a single photon. The Geiger mode is an operation mode of the APD in which the APD is operated by being applied with a reverse bias voltage greater than a breakdown voltage. If a reverse bias voltage Vbias that is greater than a breakdown voltage Va is applied to the APD 902, and the APD 902 enters the Geiger mode, a carrier generated by incidence of a single photon causes avalanche multiplication and generates a large current.

Here, the reverse bias voltage Vbias is, for example, −20 V.

The quench resistor 903 is a resistance element that stops the avalanche multiplication of the APD 902. If a photon enters the APD 902 and the avalanche multiplication generates a current, a voltage drop (voltage fluctuation) occurs in the quench resistor 903. If a cathode voltage of the APD 902 swings from the reverse bias voltage Vbias to the breakdown voltage Va or less due to the voltage drop, the avalanche multiplication stops. Subsequently, if the cathode of the APD 902 is charged through the quench resistor 903, the voltage returns to the reverse bias voltage Vbias (the voltage before fluctuation) again.

In this way, one voltage signal pulse is generated at the cathode of the APD 902 in response to incidence of a single photon. At this time, a width of the voltage signal pulse changes depending on a time constant determined by a magnitude of a resistance value of the quench resistor 903. The APD 902 and the quench resistor 903 form a sensor unit.

The inverter 904 as a buffer unit functions as a shaping unit, shapes a waveform of the voltage signal pulse generated by the APD 902 as described above, and outputs a signal pulse of which the waveform has been shaped to its output terminal.

The counter 905 receives the signal pulse output from the inverter 904 as an input and counts a rising edge of the signal pulse. The inverter 904 is used as the buffer unit because the counter 905 is configured to count the rising edge. In a case where a buffer in which polarity is not inverted is used, the counter 905 only needs to count a falling edge of the signal pulse output by the buffer.

The counter 905 is configured to be able to count the number of pulses for 16 bits, as an example. In the following description, “count value” refers to a value counted by the counter 905. The counter 905 receives a signal pulse res output from the vertical scanning unit 908 and controls a reset operation of the count value and a start timing of a count operation.

The readout switch 906 turns on in response to receiving a signal pulse sel that is sequentially output by the vertical scanning unit 908 for each row, and the count value stored in the counter 905 is written to the column memory 909 via the vertical signal line 907.

As described above, the vertical scanning unit 908 sequentially selects a row of pixels arranged in a matrix and outputs the signal pulse sel for each row. The vertical scanning unit 908 outputs the signal pulse res for controlling the reset operation of the count value and the start timing of the count operation of the counter 905.

The count value of each pixel 901 in the row selected by the vertical scanning unit 908 is written into the column memory 909 with the signal pulse sel via the vertical signal line 907, and the column memory 909 stores the count value for each column. The vertical scanning unit 908 sequentially selects the count value of each pixel 901 stored in the column memory 909 for each row and thus sequentially outputs the count value of each pixel 901 to the output unit 910.

The output unit 910 performs digital processing, such as gain processing and signal rearrangement, on the count value of each pixel 901 output from the column memory 909 and outputs the processed image signal to the outside of the imaging unit 110.

As described above, the SPAD sensor counts the photon entering the pixel 901, and the photon entering the pixel 901 is immediately converted into an electron. The electron causes the avalanche multiplication and can be detected as a large signal charge. No noise enters the SPAD sensor at the time of reading out a signal because of its mechanism, so that it is possible to capture a clear image of an object without being affected by noise, even in a dark place. Thus, the SPAD sensor is expected to be widely used as a sensor for a monitoring application and among other purposes.

However, an image signal acquired from the SPAD sensor may induce color distortion in a high luminance portion. Color distortion is described below. The image processing unit 112 performs signal processing, such as gain correction, white balance correction, and color tone correction, on RGB signals acquired from an image signal captured by the imaging unit 110 and outputs the RGB signals. At this time, if either the output of the imaging unit 110 or the RGB signals during the signal processing is saturated, a phenomenon referred to as “color distortion” occurs in which a hue deviates from its original state. For example, in a case where an orange object with a relationship of R>G>B is being imaged, as an exposure amount is increased, the R signal is saturated first. If the exposure amount is further increased from a state where the R signal is just saturated, the G signal and the B signal will increase while the R signal remains saturated, so that the hue is deviated toward yellow compared with the original state. If the color distortion phenomenon thus occurs, an image acquired by the imaging apparatus 100 may differ from an actual appearance and may be undesirable.

Causes of color distortion include a change in the SPAD sensor due to a long term use and the like, and a fact that the output signal of the SPAD sensor is not linear. If the SPAD sensor is constantly driven, as in the monitoring application, a dark count rate (DCR) changes with a usage time, and color distortion may occur. The DCR is an average value of the count values of the counter 905 detected in absence of incident light. The counter 905 counts a photon under clock control, thus making the number of counted photons less than the number of actually incident photons in a high illuminance condition. As a result, linearity of the output signal of the SPAD sensor may be collapsed, and color distortion may occur.

The present exemplary embodiment is directed to making it possible to control color distortion in a high luminance portion even if a DCR changes with a usage time.

According to the present exemplary embodiment, an operation is described in a case where the image processing unit 112 estimates a degree of change in the imaging apparatus 100 and performs achromatic processing on the high luminance portion. The change in the imaging apparatus 100 is, for example, degradation of the imaging apparatus 100 including the imaging unit (SPAD sensor) 110 and an optical system (the imaging lens 101, the diaphragm 102, and the ND filter 103), and a difference in imaging conditions.

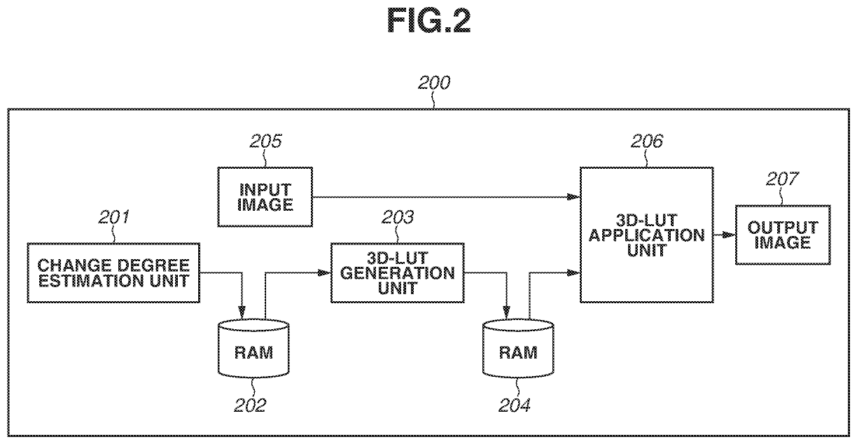

FIG. 2 illustrates a configuration example of an achromatic processing unit 200. The achromatic processing unit 200 is provided in the image processing unit 112 in FIG. 1 and includes a change degree estimation unit 201, a RAM 202, a 3D-LUT generation unit 203, a RAM 204, and a 3D-LUT application unit 206. The achromatic processing unit 200 estimates the degree of change in the imaging apparatus 100 and performs achromatic processing on a high luminance portion of an input image 205. The image processing unit 112 generates, for example, the input image 205 in a YUV format based on the count value output from the imaging unit 110. Y represents a luminance signal. U represents a difference between the luminance signal and a blue component. V represents a difference between the luminance signal and a red component. The input image 205 is based on the output signal from the imaging unit 110. As described above, the image processing unit 112 is an output unit that outputs the input image 205 from the output signal output from the imaging unit 110.

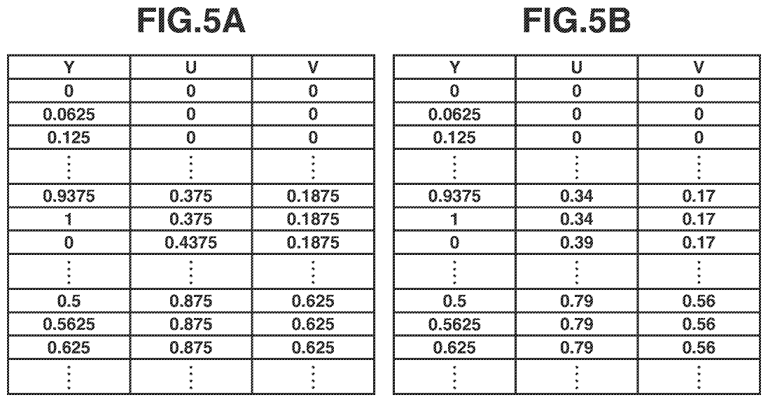

Initially, the change degree estimation unit 201 estimates the degree of change in the imaging apparatus 100 for each region of the input image 205 and temporarily stores the degree of change in the imaging apparatus 100 in the RAM 202. Next, the 3D-LUT generation unit 203 generates a 3D-LUT based on the degree of change in the imaging apparatus 100 read out from the RAM 202 and stores the 3D-LUT in the RAM 204. The 3D-LUT is, for example, a conversion table for YUV values of the input image 205 and YUV values of an output image 207 as illustrated in FIGS. 5A and 5B. The 3D-LUT converts the YUV values of each pixel of the input image 205 and outputs the YUV values of each pixel of the output image 207.

Subsequently, the 3D-LUT application unit 206 converts the YUV values of the input image 205 based on the 3D-LUT read out from the RAM 204 and outputs the output image 207. Here, the RAMs 202 and 204 are expressed as separate RAMs, but they may be separate areas in the same RAM.

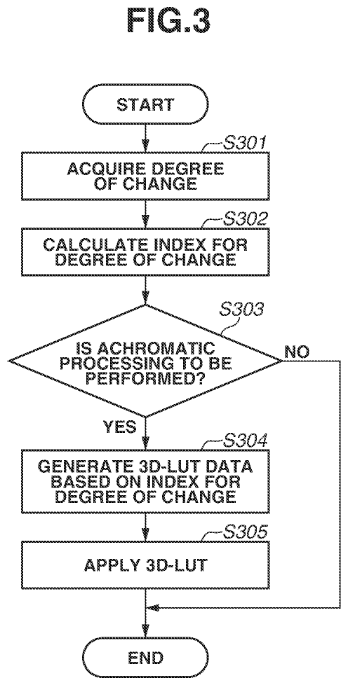

FIG. 3 is a flowchart illustrating a method for controlling the image processing unit 112 in FIG. 1. In step S301, the change degree estimation unit 201 estimates the degree of change in the imaging apparatus 100 for each region of an image and stores it in the RAM 202. For example, the change degree estimation unit 201 estimates the degree of change in the imaging apparatus 100 based on a drive time of the imaging apparatus 100 acquired from the system timer 123 or the number of input photons for each region of the imaging unit 110. The number of input photons corresponds to the count value output by the imaging unit 110. The image processing unit 112 acquires the degree of change in the imaging apparatus 100 from the RAM 202.

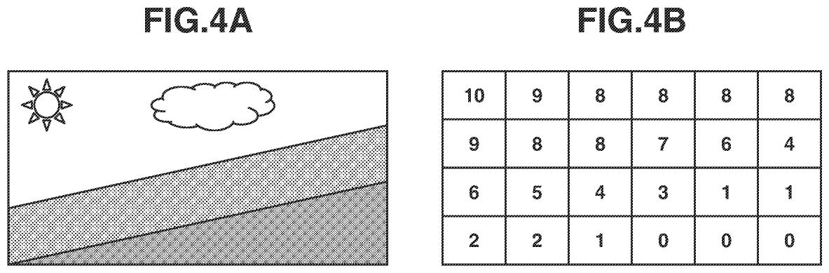

FIGS. 4A and 4B illustrate an example of the degree of change in the imaging apparatus 100 for each region of an image. If the imaging apparatus 100 is fixed at an angle of view of an image illustrated in FIG. 4A and driven constantly, the degree of change is estimated by being scored for each of 6*4 regions, as illustrated in FIG. 4B. The score is expressed from 0 to 10, and the greater number indicates that the change in the imaging apparatus 100 increases, and color distortion is more likely to occur. An upper part of the image in FIG. 4A has a high score because the number of photons input to the imaging unit 110 is always large due to an influence of sunlight, and a lower part of the image has a low score because a luminance level is low even during the day, and the number of photons input to the imaging unit 110 is small.

The change degree estimation unit 201 may estimate the degree of change in the imaging apparatus 100 for each region of the image based on a cumulative value of the output signal for each region of the imaging unit 110 for each frame. The degree of change in the imaging apparatus 100 may also be a degree of change in the imaging unit 110. In such a case, the degree of change in the imaging apparatus 100 for each region of the image described above becomes the degree of change in each region of the imaging unit 110. The change degree estimation unit 201 may estimate the degree of change in the imaging apparatus 100 based on at least one of the cumulative value of the output signals from the imaging unit 110 or the drive time of the imaging apparatus 100.

In step S302, the image processing unit 112 calculates an index for the degree of change used for achromatic processing based on the degree of change in the imaging apparatus 100 for each region of the image. For example, the image processing unit 112 uses a maximum value of the degree of change in the imaging apparatus 100 for each region of the image as the index for the degree of change. For example, in the case of FIG. 4B, the index for the degree of change is ten. The index for the degree of change may be an average value or a median value of the degrees of changes in the imaging apparatus 100 for the regions of the image.

In step S303, the image processing unit 112 determines whether achromatic processing is performed based on the index for the degree of change calculated in step S302. For example, the image processing unit 112 determines that achromatic processing is to be performed if the index for the degree of change is more than or equal to a threshold value, and determines that achromatic processing is not to be performed if the index for the degree of change is less than the threshold value. If the image processing unit 112 determines that achromatic processing is to be performed (YES in step S303), the processing proceeds to step S304. If the image processing unit 112 determines that achromatic processing is not to be performed (NO in step S303), the processing in the flowchart in FIG. 3 is terminated.

In step S304, the 3D-LUT generation unit 203 generates a 3D-LUT based on the index for the degree of change calculated in step S302 and stores it in the RAM 204. FIGS. 5A and 5B illustrate a part of data in the 3D-LUT. FIG. 5A illustrates an example of data that does not reflect achromatic processing, and FIG. 5B illustrates an example of data having been subjected to achromatic processing. In the data having been subjected to achromatic processing, data of UV components are small, and an effect of achromatic processing is acquired by reducing saturation. Here, the 3D-LUT is a 17-grid 3D-LUT for YUV signals, and is an example of a LUT that is incremented from the Y component, but a LUT for a signal other than YUV signals may be used, or the data may be arranged in a different order.

As described above, the 3D-LUT generation unit 203 is a determination unit that determines an adjustment method for the input image 205 based on at least one of the cumulative value of the output signals from the imaging unit 110 or the drive time of the imaging apparatus 100.

In step S305, the 3D-LUT application unit 206 acquires the data of the 3D-LUT generated in step S304 from the RAM 204, converts the YUV values of the input image 205 based on the acquired data, and thus acquires the output image 207 having been subjected to achromatic processing. In other words, the 3D-LUT application unit 206 functions as an adjustment unit, uses the 3D-LUT to adjust colors of the input image 205, and outputs the output image 207. For example, for the conversion tables illustrated in FIGS. 5A and 5B, the 3D-LUT application unit 206 adjusts the U value and the V value of the input image 205 in the YUV format based on the output signal of the imaging unit 110. As described above, the 3D-LUT application unit 206 is an output unit that outputs the output image 207 acquired by adjusting the input image 205 based on the adjustment method determined in step S304.

As described above, according to the present exemplary embodiment, the image processing unit 112 performs achromatic processing based on the degree of change in the imaging apparatus 100, thus controlling an influence of color distortion even with a change in the DCR with usage time. The image processing unit 112 is also able to control color distortion of the high luminance portion even if the apparatus changes with time or the DCR changes with the usage time.

According to the present exemplary embodiment, the operation in a case where the 3D-LUT is generated to convert the input image 205 is described as achromatic processing, but by a calculation circuit that adjusts a saturation component may be arranged to perform achromatic processing. In other words, the 3D-LUT application unit 206 uses the 3D-LUT to adjust saturation of the input image 205 based on the output signal of the imaging unit 110. In such a case, achromatic processing may be performed if the index for the degree of change is more than or equal to the threshold value, or a level of achromatization may be adjusted continuously based on the index for the degree of change.

According to the present exemplary embodiment, the degree of change in the imaging apparatus 100 is estimated from the drive time, the number of input photons for each region, and the like, but it may be estimated from an environmental factor, such as temperature information from a thermistor.

According to the present exemplary embodiment, the degree of change in the imaging apparatus 100 is expressed as a score from 0 to 10, but it may also be abstractly expressed, for example, as large, medium, and small.

Next, a second exemplary embodiment is described. In the second exemplary embodiment, descriptions of components similar to those in the first exemplary embodiment are omitted. According to the first exemplary embodiment, the 3D-LUT is generated based on the degree of change in the imaging apparatus 100, but the effect of achromatic processing may be too strong or too weak depending on a level of the output signal of the imaging unit 110. Thus, according to the second exemplary embodiment, a method for generating a 3D-LUT is described in which a level of achromatic processing is changed with the number of input photons reflected in addition to the degree of change in the imaging apparatus 100.

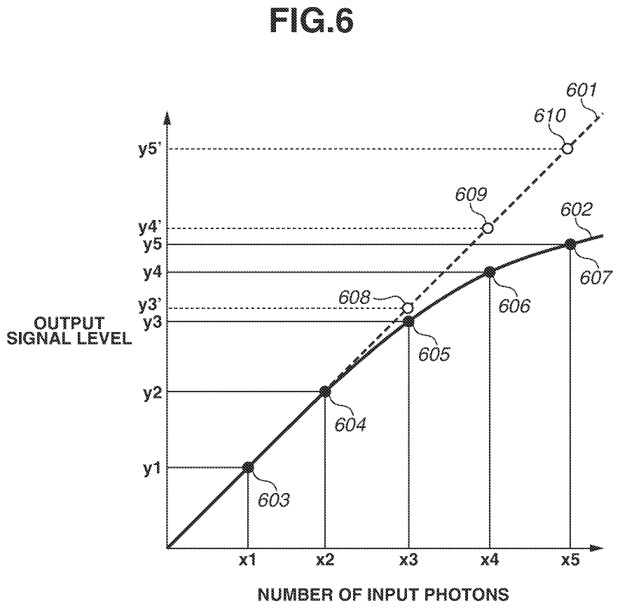

FIG. 6 illustrates an example of a relationship between the number of input photons and an output signal level of the imaging unit (SPAD sensor) 110. A horizontal axis indicates the number of input photons of the imaging unit 110, and a vertical axis indicates the level of the output signal of the imaging unit 110. A relationship 602 indicates an actual input-output relationship of the imaging unit 110. A relationship 601 indicates an ideal linear input-output relationship. In the imaging unit 110, as the number of input photons is greater, the number of counted photons becomes smaller than the number of actually incident photons, so that linearity is collapsed in the relationship 602 compared with the relationship 601 in which the output signal level is linear. At points 603 and 604 where the number of incident photons is small, the linearity of the relationship 602 is maintained. However, at points 605, 606, and 607 where the number of incident photons increases, the linearity of the relationship 602 collapses, and the output signal level decreases.

For the number of input photons “*3” in the relationship 601 in which the linearity is maintained, the output signal level of “y3” would be detected at a point 608, but in the relationship 602 in which the linearity collapses, the output signal level of “y3” is detected at the point 605. Similarly, for the number of input photons “*4” in the relationship 601 in which the linearity is maintained, the output signal level of “y4” would be detected at a point 609, but in the relationship 602 in which the linearity collapses, the output signal level of “y4” is detected at the point 606. Similarly, for the number of input photons “*5” in the relationship 601 in which the linearity is maintained, the output signal level of “y5” would be detected at a point 610, but in the relationship 602 in which the linearity collapses, the output signal level of “y5” is detected at the point 607.

Thus, the image processing unit 112 is to convert the nonlinear relationship 602 into the linear relationship 601. The image processing unit 112 outputs the input image 205 based on the output signal from the imaging unit 110 so that the relationship between the number of input photons of the imaging unit 110 and the output signal from the imaging unit 110 approaches a linear relationship. The nonlinearity of the relationship 602 may be applied as known information with a conversion function or the like defined, but, as the imaging apparatus 100 changes, conversion is performed while including an influence of the change, which leads to an increase in a conversion error. In particular, at a point with a large number of input photons, such as the point 607, the amount of change due to conversion is also large, so that the conversion error increases, and an influence of color distortion increases. Therefore, achromatic processing is performed in accordance with the number of input photons, for each degree of change in the imaging apparatus 100.

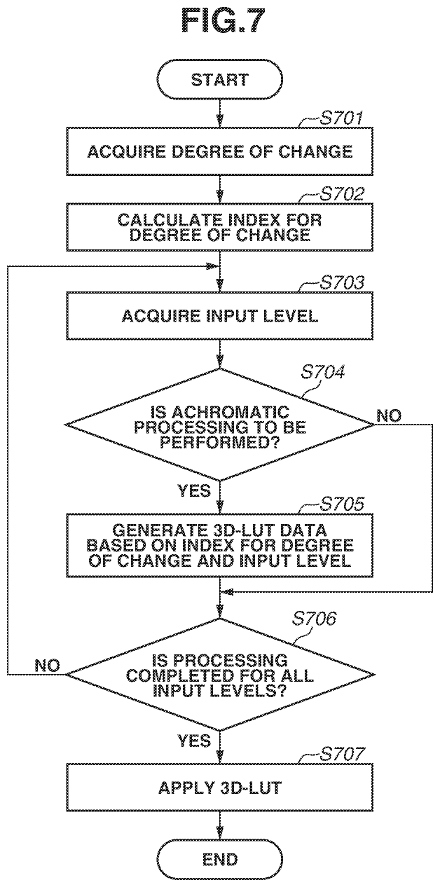

FIG. 7 is a flowchart illustrating a method for controlling the image processing unit 112 according to the second exemplary embodiment. In step S701, the image processing unit 112 performs processing similar to that in step S301 in FIG. 3. In step S702, the image processing unit 112 performs processing similar to that in step S302 in FIG. 3.

In step S703, the image processing unit 112 acquires an input level for generating a 3D-LUT. The input level is, for example, the count value (the number of input photons) of each pixel output by the imaging unit 110, and is the output signal level of the imaging unit 110.

In step S704, the image processing unit 112 determines whether achromatic processing is to be performed based on the index for the degree of change calculated in step S702 and the input level acquired in step S703. For example, the image processing unit 112 calculates a color distortion concern score based on the index for the degree of change and the input level, and determines that achromatic processing is to be performed if the color distortion concern score is more than or equal to a threshold value. The image processing unit 112 determines that achromatic processing is not to be performed if the color distortion concern score is less than the threshold value. If the image processing unit 112 determines that achromatic processing is to be performed (YES in step S704), the processing proceeds to step S705. If the image processing unit 112 determines that achromatic processing is not to be performed (NO in step S704), the processing proceeds to step S706.

In step S705, the 3D-LUT generation unit 203 generates a 3D-LUT from which a level of achromatic processing is acquirable based on the index for the degree of change calculated in step S702 and the input level acquired in step S703, and stores the 3D-LUT in the RAM 204.

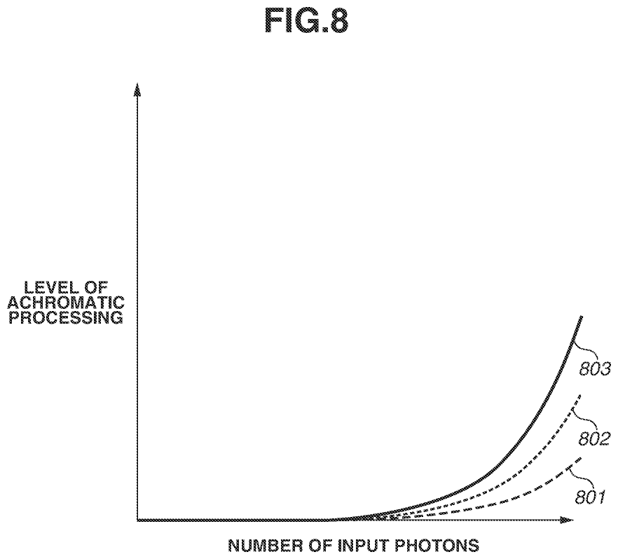

FIG. 8 illustrates an example of a level of achromatic processing. A horizontal axis indicates the number of input photons of the imaging unit 110, and a vertical axis indicates a level of achromatic processing to be reflected in the 3D-LUT generation unit 203. Three curves 801 to 803 correspond to the indices for the degree of change. The curve 801 is a curve in a case where the index for the degree of change is small. The curve 802 is a curve in a case where the index for the degree of change is medium. The curve 803 is a curve in a case where the index for the degree of change is large. If the index for the degree of change is small, the influence of color distortion is small even in the high luminance portion, so that a small level of achromatic processing is sufficient. As the index for the degree of change increases, the influence of color distortion increases, particularly in the high luminance portion, so that the level of achromatic processing is increased. Here, an example is described in which the level of achromatic processing is continuously increased according to the number of input photons, but a threshold value may be provided, and the level of achromatic processing may be increased by stages. The 3D-LUT generation unit 203 determines an adjustment method so that an adjustment amount becomes larger for a pixel of which a pixel value in the input image 205 is more than or equal to a predetermined value.

In step S706, the image processing unit 112 determines whether processing is completed for all the input levels necessary to generate the 3D-LUT. If the image processing unit 112 determines that the processing is completed (YES in step S706), the processing proceeds to step S707. If the image processing unit 112 determines that the processing is not completed (NO in step S706), the processing returns to step S703, and is continued for each input level described above.

In step S707, the 3D-LUT application unit 206 acquires the data of the 3D-LUT generated in step S705 from the RAM 204 and converts the YUV values of the input image 205 based on the acquired data to acquire the output image 207 having been subjected to achromatic processing. In other words, the 3D-LUT application unit 206 adjusts the high luminance portion of the input image 205 based on the output signal of the imaging unit 110 so that a relationship between the number of input photons of the imaging unit 110 and the output signal of the imaging unit 110 approaches a linear relationship as in FIG. 6. The 3D-LUT application unit 206 uses the 3D-LUT to adjust the high luminance portion of the input image 205 based on the output signal of the imaging unit 110 at the level of achromatic processing in FIG. 8. The level of achromatic processing in FIG. 8 indicates an adjustment level.

As described above, according to the present exemplary embodiment, the image processing unit 112 is able to control an influence of color distortion by performing achromatic processing that reflects the input level (the number of input photons) in step S703 in addition to the degree of change in the imaging apparatus 100.

According to the first and the second exemplary embodiments, the 3D-LUT generation unit 203 and the 3D-LUT application unit 206 are described separately, but the 3D-LUT generation unit 203 and the 3D-LUT application unit 206 may be integrated.

The system control unit 120 may execute a program to perform the above-described processing of the image processing unit 112. The imaging apparatus 100 is applicable to a smartphone, a tablet, an industrial camera, a medical camera, a vehicle camera, or the like in addition to a digital camera or a video camera.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-025551, filed Feb. 21, 2023, which is hereby incorporated by reference herein in its entirety.

What is claimed is:

1. An apparatus comprising:
a sensor having a photodiode;
at least one processor; and
a memory coupled to the at least one processor, the memory storing instructions that, when executed by the at least one processor, cause the at least one processor to:
output a first image based on an output signal from the sensor;
determine an adjustment method for an image based on at least one of a cumulative value of the output signal or a drive time of the apparatus; and
output a second image acquired by adjusting the first image based on the adjustment method.

2. The apparatus according to claim 1, wherein the instructions cause the at least one processor to determine the adjustment method so that an adjustment amount becomes larger with respect to a pixel of which a pixel value of the first image is more than or equal to a predetermined value.

3. The apparatus according to claim 1, wherein the instructions cause the at least one processor to output the first image based on the output signal from the sensor so that a relationship between a number of input photons of the sensor and the output signal from the sensor approaches a linear relationship.

4. The apparatus according to claim 1, wherein the sensor further includes a counter configured to count a signal of the avalanche photodiode.

5. The apparatus according to claim 4,
wherein the sensor further includes a shaping circuit configured to shape a waveform of a signal of the photodiode, and
wherein the counter counts a signal that is shaped by the shaping circuit.

6. The apparatus according to claim 1, wherein the instructions cause the at least one processor to determine the adjustment method based on the cumulative value of the output signal for each region of the sensor.

7. The apparatus according to claim 1,
wherein the instructions cause the at least one processor to estimate a degree of change in the apparatus based on at least one of the cumulative value of the output signal or the drive time of the apparatus, and
wherein the adjustment method is determined based on the degree of change in the apparatus.

8. The apparatus according to claim 7, wherein the instructions cause the at least one processor to determine to perform the adjustment method in a case where an index based on the degree of change in the apparatus for each region of the image is more than or equal to a threshold value and to determine not to perform the adjustment method in a case where the index based on the degree of change in the apparatus for each region of the image is less than the threshold value.

9. The apparatus according to claim 8, wherein the index is a maximum value, an average value, or a median value of the degrees of changes in the apparatus for the regions of the image.

10. The apparatus according to claim 1, wherein the adjustment method is processing for adjusting color of the first image.

11. The apparatus according to claim 10, wherein the adjustment method is processing for adjusting a U value and a V value of the first image in a YUV format based on the output signal from the sensor.

12. The apparatus according to claim 10, wherein the adjustment method is processing for adjusting saturation of the first image based on the output signal from the sensor.

13. The apparatus according to claim 1, wherein the adjustment method is processing for adjusting the first image based on the output signal from the sensor using a look-up table.

14. The apparatus according to claim 1, wherein the instructions cause the at least one processor to determine, for each level assigned to the output signal from the sensor, to adjust the first image in a case where a score based on the level is more than or equal to a threshold value and not to adjust the first image in a case where the score based on the level is less than the threshold value.

15. The apparatus according to claim 14, wherein the instructions cause the at least one processor to determine to adjust the first image based on the level and an adjustment level determined based on the cumulative value of the output signal and the drive time of the apparatus.

16. A method for controlling an apparatus having a sensor, the method comprising:
outputting a first image from an output signal output from the sensor;
determining an adjustment method for an image based on at least one of a cumulative value of the output signal or a drive time of the apparatus; and
outputting a second image acquired by adjusting the first image based on the adjustment method.

17. The method according to claim 16, further comprising determining the adjustment method so that an adjustment amount becomes larger with respect to a pixel of which a pixel value of the first image is more than or equal to a predetermined value.

18. The method according to claim 16, further comprising outputting the first image based on the output signal from the sensor so that a relationship between the number of input photons of the sensor and the output signal from the sensor approaches a linear relationship.

19. The method according to claim 16, further comprising determining the adjustment method based on the cumulative value of the output signal for each region of the sensor.

20. A non-transitory computer-readable storage medium storing a program for causing a computer to execute a method for controlling an apparatus having a sensor, the method comprising:
outputting a first image from an output signal output from the sensor;
determining an adjustment method for an image based on at least one of a cumulative value of the output signal or a drive time of the apparatus; and
outputting a second image acquired by adjusting the first image based on the adjustment method.
